(19) United States
(12) Patent Application Publication
(10) Pub. No.: US 2026/0332718 A1
(43) Pub. Date: Oct. 22, 2026

(54) COMPUTER-READABLE STORAGE MEDIUM, INFORMATION PROCESSING METHOD, AND INFORMATION PROCESSING APPARATUS

(71) Applicant: CANON KABUSHIKI KAISHA, Tokyo (JP)

(72) Inventor: YUTO OSADA, Kanagawa (JP)

(21) Appl. No.: 19/529,939

(22) Filed: Feb. 4, 2026

(30) Foreign Application Priority Data
Feb. 6, 2025 (JP) 2025-018550

(51) Int. Cl. H04N 1/387; H04N 1/393

(52) U.S. Cl. CPC H04N 1/3872; H04N 1/393

(57) ABSTRACT

In embodiments, a computer-readable storage medium stores instructions for causing a computer to perform: a position setting step of setting an arrangement position of an additional object indicating a part serving as a support of an upper object, in a lower layer behind an upper layer including the upper object; and a display control step of displaying and controlling the additional object set in arrangement position in the position setting step.

### BACKGROUND

### Field of the Technology

The present disclosure relates to a computer-readable storage medium, an information processing method, and an information processing apparatus.

### Description of the Related Art

Conventionally, an apparatus which has a capability of editing an object composed of digital data corresponding to a tangible object arranged on a paper surface has been used. The apparatus assigns different hierarchies to each of a plurality of objects being displayed, so that it is possible to perform various kinds of processing every hierarchy. Further, it is disclosed in Japanese Patent Laid-Open No. 2006-101390 (hereinafter, referred to as Literature 1) as such an apparatus in that a technique brings a selectable method for printing an object every hierarchy in the order from lower hierarchy, as a printing method.

However, there is a case that issue occurs in a case where a tangible object which is printed and produced in a manner with the technique disclosed in Literature 1 is arranged. Therefore, it is desirable to improve usability relating to the processing based on the produced matters.

### SUMMARY

A program according to one aspect of the present disclosure causes a computer to perform: a position setting step of setting an arrangement position of an additional object indicating a part serving as a support of an upper object, in a lower layer behind an upper layer including the upper object; and a display control step of displaying and controlling the additional object set in arrangement position in the position setting step.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a print system according to one or more aspects of the present disclosure;

FIG. 2 is a diagram illustrating an example of a hardware configuration of an image output apparatus;

FIG. 3 is a diagram illustrating an example of a hardware configuration of an information processing apparatus;

FIG. 4 is a block diagrams illustrating functions of the print system;

FIG. 5 is a diagram illustrating an example of a layout data editing screen displayed on a display of the information processing apparatus;

FIG. 6 is a diagram illustrating an example of a layer setting screen displayed on the display of the information processing apparatus;

FIG. 7 is a diagram illustrating examples of layout data and a layer configuration;

FIG. 8 is a diagram illustrating an example of a print setting screen displayed on the display of the information processing apparatus;

FIG. 9 is a diagram illustrating an example of the print setting screen in a case where an instruction to print layer by layer is received on the print setting screen in FIG. 8;

FIG. 10 is a flowchart illustrating additional object addition processing;

FIG. 11 is a flowchart illustrating object overlapping determination processing in S1005 in FIG. 10;

FIG. 12 is a flowchart illustrating object display processing in S1006 in FIG. 10;

FIG. 13 is a transition diagram of layout data by the additional object addition processing;

FIG. 14 is a diagram illustrating an example of a processing result of the additional object addition processing;

FIG. 15 is a flowchart illustrating support shape change processing according to one or more aspects of the present disclosure;

FIG. 16 is a diagram illustrating an example of a print setting screen in a case where a support color is set according to one or more aspects of the present disclosure;

FIG. 17 is a diagram illustrating an example of the print setting screen in a case where a boundary line between a support and an object is displayed according to one or more aspects of the present disclosure;

FIG. 18 is a diagram illustrating an example of the print setting screen in a case where a glue margin is displayed according to one or more aspects of the present disclosure;

FIG. 19 is a diagram illustrating an example of the print setting screen in a case where a support magnification is set according to one or more aspects of the present disclosure;

FIG. 20 is a diagram illustrating an example of the print setting screen in a case where the support color is set to a color of a forefront object according to one or more aspects of the present disclosure;

FIG. 21 is a flowchart illustrating additional object ink saving processing according to one or more aspects of the present disclosure;

FIG. 22 is a diagram illustrating an example of a print setting screen in a case where only support contour is displayed according to one or more aspects of the present disclosure;

FIG. 23 is a diagram illustrating an example of the print setting screen in a case where a support color is set to gray according to one or more aspects of the present disclosure;

FIG. 24 is a flowchart illustrating automatic object arrangement processing according to one or more aspects of the present disclosure; and

FIG. 25 is a diagram illustrating an example of a print setting screen in a case where objects are automatically arranged according to one or more aspects of the present disclosure.

### DESCRIPTION OF THE EMBODIMENTS

Hereinafter, preferred embodiments of the present disclosure will be described in detail with reference to the accompanying drawings. It should be noted that the following embodiments do not limit the matters of the present disclosure, and not all combinations of features described in the following embodiments are necessarily essential to the solutions of the present disclosure. It should be noted that the same reference numbers are given to the same components.

### Overview

Conventionally, a layout data creation application has been released. The application enables creation of layout data on a photograph album, a poster, and the like by causing a user to arrange a plurality of objects of texts and images on a screen. In such an application, layout data in which objects of texts and images suitable for a purpose of creating the layout data are previously arranged is prepared as a template. By using the template, the user easily creates objective layout data. For example, in a case where a purpose of creating the layout data is fabrication of a paper fan for cheering an artist, a template in which objects such as a text of a tentative name and an image like a heart and a star are arranged may be provided. The user can easily create the layout data suitable for the purpose by editing the objects of the texts and the images previously arranged in such a template. In particular, such a template can be effectively utilized in "supporting my fave". The "supporting my fave" is an expression in order to collectively refer to activities for cheering a specific character such as an idle, an actor, an influencer, and an animation character. Such a character is referred to as a "my fave". Such activities include viewing of a live concert and an event of the "my fave", buying of merchandise of the "my fave", and creation of handmade goods for cheering the "my fave". Further, in a case where the user goes to a live concert and an event, the user brings a paper fan for cheering the "my fave" in some cases. The present disclosure can be effectively used for a template of such a paper fan.

Further, by using the layout data, it is possible to fabricate a paper fan in which tangible objects created from printed matters obtained by printing the objects of the texts and the images are three-dimensionally arranged. For example, the user may fabricate the tangible objects by cutting out a cardboard or a color board by using printed matters of the objects based on the layout data, as paper patterns. The user may fabricate a paper fan suitable for the purpose by arranging such tangible objects to overlap each other. The user can confirm rough arrangement positions and assumed appearance of the tangible objects before printing of the objects of the texts and the images, by arranging the objects on a screen in an application that can use the layout data. However, a work of arranging the objects on the screen in consideration of overlapping of the tangible objects cut and created from the printed matter may be a work troublesome for the user. In addition, depending on thicknesses of the tangible objects, a work of arranging the tangible objects at intended position may be a work troublesome for the user.

A technique being selectable a printing method of performing printing in such an order that the tangible objects can be easily pasted on a board is disclosed. The technique facilitates overlapping arrangement of the tangible objects. In addition, a technique for avoiding collectively printing objects whose hierarchy positioned in a different hierarchy in an overlapping state in case where objects positioned in a same hierarchy are printed is disclosed as well. However, in a case where the plurality of tangible objects are pasted on a board by overlapping parts of the tangible objects, a use case where gaps may occur between the tangible objects can be assumed. In the use case, presence of the gaps among the tangible objects may cause the following. For example, it can be assumed that bonding between the tangible objects may become insufficient. Alternatively, it can be assumed that overlapping parts of the tangible objects may be distorted. Alternatively, it can be assumed that the tangible objects may be arranged at positions deviated from intended positions. In consideration of these assumptions, in a case where the plurality of tangible objects are arranged while partially overlapping each other, it is desirable to fill the gaps among the tangible objects to facilitate overlapping arrangement of the plurality of tangible objects. However, such a work is troublesome as a manual work and requires time and efforts.

Therefore, in the present disclosure, an arrangement position of an additional object indicating a part serving as a support of an upper object is set in a lower layer behind an upper layer (hierarchy) including the upper object, and the additional object set in arrangement position is displayed and controlled. Therefore, the displayed and controlled additional object is displayed at a position suitable for a support of the upper object. Thus, a tangible additional object produced by cutting out a cardboard or the like by using a printed matter of the additional object as a paper pattern is suitable for the support of the tangible object corresponding to the upper object. Therefore, even when the tangible objects printed and produced are actually arranged on a board, the tangible additional object corresponding to the additional object can be arranged at a position where a gap is assumed to be formed with respect to the board, which makes it possible to prevent a trouble. This makes it possible to improve usability relating to the processing based on the produced matters. The present disclosure is specifically described below.

### FIRST EMBODIMENT

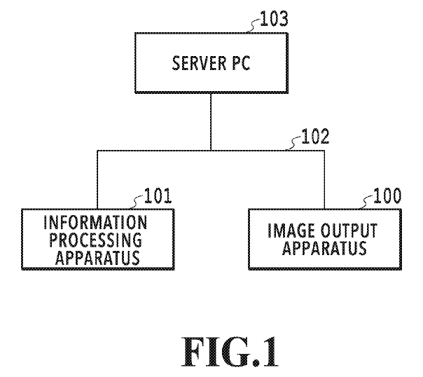

FIG. 1 is a diagram illustrating a configuration example of a print system according to a first embodiment. The print system includes an image output apparatus 100, an information processing apparatus 101, and a server PC 103. The print system realizes a layout data editing function for the image output apparatus 100. In the print system, layout data is edited in the information processing apparatus 101. Further, in the print system, a print job is transmitted from the information processing apparatus 101 to the image output apparatus 100. The print job is appropriately created, for example, based on an editing work of various kinds of print settings and the like performed on a screen of the information processing apparatus 101.

More specifically, the information processing apparatus 101 establishes communication with the server PC 103 and the image output apparatus 100 through a network 102, and can transmit/receive various kinds of data. The network 102 is a communication facility for transmitting various kinds of data. The communication facility includes a communication medium and a communication apparatus. Examples of the communication medium include Bluetooth(R), a wireless LAN, a wired LAN, a communication carrier line, an optical fiber line, and a telephone line. The communication medium may be infrared rays, millimeter waves, or the like. Examples of the communication apparatus include a router, a switching hub, a wireless antenna, an optical repeater, and a wiring member. The information processing apparatus 101 and the image output apparatus 100 may be connected through Bluetooth(R). The server PC 103 may provide the layout data editing function as a cloud service. In this case, it is sufficient for each of the information processing apparatus 101 and the image output apparatus 100 to transmit/receive various kinds of data relating to layout data editing through the cloud service. The cloud service may be a service provided from unillustrated various kinds of servers.

Examples of the information processing apparatus 101 include a client PC, a smartphone, and a tablet. The user can perform a layout data editing work of a poster, a flyer, and the like by using the information processing apparatus 101. In the editing work, a part of editing of layout data, layout data processing, rendering processing, and the like can be requested from the information processing apparatus 101 to the server PC 103. Further, the information processing apparatus 101 can generate a print job by imparting print setting to edited layout data, and transmit the generated print job to the image output apparatus 100.

Each of the number of information processing apparatuses 101, the number of server PCs 103, and the number of image output apparatuses 100 is not limited to one, and may be plural. The print system may not include the server PC 103, and the information processing apparatus 101 may perform the above-described processing. An IoT apparatus can establish communication with the information processing apparatus 101, the server PC 103, and the image output apparatus 100 through the network 102, and transmit/receive various kinds of data. For example, in a case where the IoT apparatus is a camera, image data captured by the camera is transmitted to the information processing apparatus 101 through the network 102, and the user can perform an editing work using the transmitted image data and existing layout data. For example, new layout data in which the transmitted image data is incorporated as background data in a lowest layer may be created.

Next, a print execution example is described. In the present embodiment, a use case where a print job is transmitted from a print application installed in the information processing apparatus 101 to the image output apparatus 100 through a printer driver is assumed. For example, it is assumed that the print application and the printer driver are installed in the information processing apparatus 101. The print application can acquire device information on the associated image output apparatus 100 and print parameters from the printer driver, and edit print setting based on print parameters appropriately selected by the user from the acquired print parameters. The print parameters include a sheet type, a sheet size, print quality, and the like.

A print job is configured based on the above-described print setting and layout data image that is subjected to layout data rendering processing by the server PC 103. The configured print job is transmitted to the image output apparatus 100 through a spool of the printer driver. The image output apparatus 100 performs print processing based on the received print job transmitted from the information processing apparatus 101. More specifically, the image output apparatus 100 compares the print setting included in the print job and main body information to determine whether printing is normally performable. In a case where it is determined that printing is normally performable, the image output apparatus 100 continues printing. In a case where it is determined that printing is not normally performable, a warning message may be displayed on a main body panel (not illustrated) of the image output apparatus 100 to represent a reason why printing is not normally performable to the user. The main body information includes sheet information fed to the image output apparatus 100. The sheet information includes a sheet type, a sheet size, and the like.

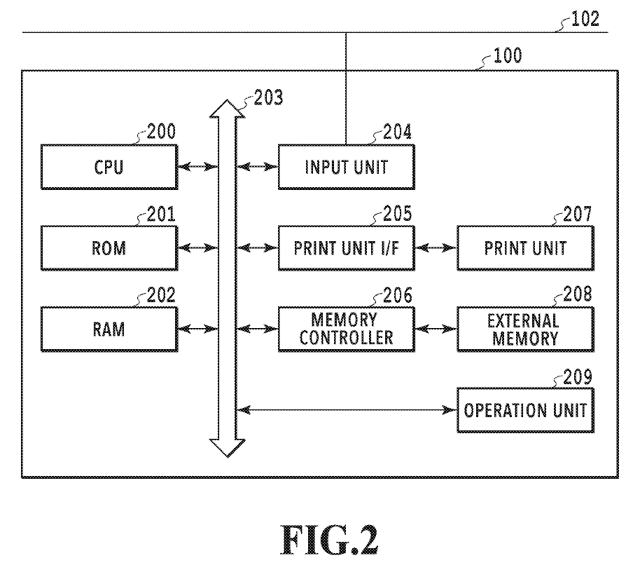

FIG. 2 is a diagram illustrating an example of a hardware configuration of the image output apparatus 100. The image output apparatus 100 includes a CPU 200, a ROM 201, a RAM 202, an input unit 204, a print unit I/F 205, a memory controller 206, a print unit 207, an external memory 208, and an operation unit 209. Each of the CPU 200, the ROM 201, the RAM 202, the input unit 204, the print unit I/F 205, the memory controller 206, and the operation unit 209 can transmit/receive various kinds of signals through a system bus 203. The print unit 207 transmits/receives various kinds of signals through the print unit I/F 205. The print unit 207 is a printer engine. The external memory 208 transmits/receives various kinds of signals through the memory controller 206. The CPU 200 totally controls the entire image output apparatus 100. The CPU 200 performs various kinds of processing based on control programs stored in the ROM 201 or control programs stored in the external memory 208. The CPU 200 outputs an image signal as output information to the print unit 207 through the system bus 203 and the print unit I/F 205. The CPU 200 can perform communication processing with the information processing apparatus 101 through the input unit 204. For example, the CPU 200 can notify the information processing apparatus 101 of various kinds of information in the image output apparatus 100 through the input unit 204. Alternatively, the CPU 200 can receive output data to be output to the print unit 207 through the input unit 204. The RAM 202 functions as a main memory, a work area, and the like for the CPU 200. The RAM 202 is configured such that a memory capacity can be expanded by an optional RAM when the optional RAM is connected to an unillustrated expansion port. The RAM 202 is used as an output information development area, an environment data storage area, a nonvolatile memory, and the like. Access to the external memory 208 is controlled by the memory controller 206. Examples of the external memory 208 include a hard disk drive (HDD), and an IC card. The external memory 208 is optionally connectable. The external memory 208 stores font data, an emulation program, form data, information about a type and a size of fed sheet, and a determination result whether printing is normally performable at the time of receiving a print job. The operation unit 209 includes an unillustrated panel, and can display various kinds of information. For example, in the case where it is determined that printing is not normally performable, the image output apparatus 100 may display a warning message on the unillustrated panel to present the reason why printing is not normally perforable to the user.

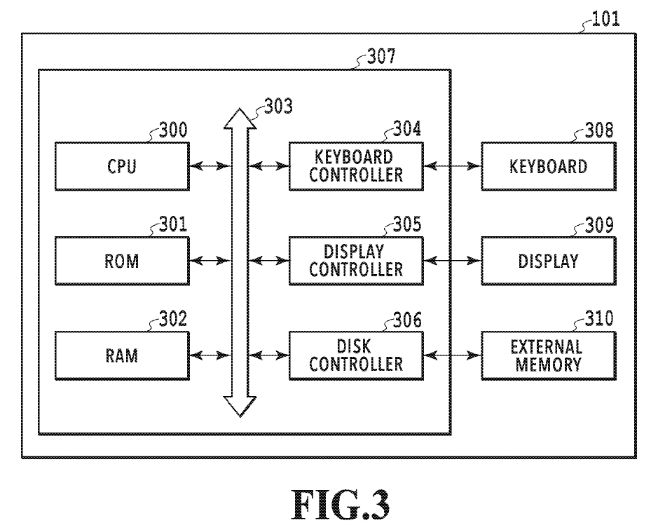

FIG. 3 is a diagram illustrating an example of a hardware configuration of the information processing apparatus 101. A CPU 300, a ROM 301, a RAM 302, a keyboard controller 304, a display controller 305, and a disk controller 306 are included inside a housing 307. Each of the CPU 300, the ROM 301, the RAM 302, the keyboard controller 304, the display controller 305, and the disk controller 306 can transmit/receive various kinds of signals through a main bus 303. A keyboard 308, a display 309, and an external memory 310 are included outside the housing 307. The CPU 300 reads out various kinds of programs from the external memory 310 through the disk controller 306, and develops the read various kinds of programs to the RAM 302. The various kinds of programs stored in the external memory 310 are, for example, control programs, system programs, and application programs. The CPU 300 performs various kinds of data processing and display control of the display 309 by executing the various kinds of programs developed to the RAM 302. The CPU 300 may read out not only the various kinds of programs stored in the external memory 310 but also various kinds of programs stored in the ROM 301. For example, in a case where control programs are stored in the ROM 301, the CPU 300 may read out the control programs stored in the ROM 301. The disk controller 306 controls access to the external memory 310. Examples of the external memory 310 include a hard disk drive (HDD), a CD-ROM, a DVD-ROM, and a USB. The RAM 302 is configured such that a memory capacity can be expanded by an unillustrated optional RAM and the like, and is mainly used as a work area for the CPU 300. The keyboard controller 304 controls key input from the keyboard 308. Alternatively, the keyboard controller 304 may control input from an unillustrated pointing device. The display controller 305 controls display of the display 309. The server PC 103 has a hardware configuration similar to the hardware configuration of the information processing apparatus 101 in FIG. 3, but may not include a component that is not necessarily essential, like the display 309. The CPU 300 may be a dedicated circuit such as an ASIC. The CPU 300 and the dedicated circuit are examples of a hardware circuit and a hardware processor.

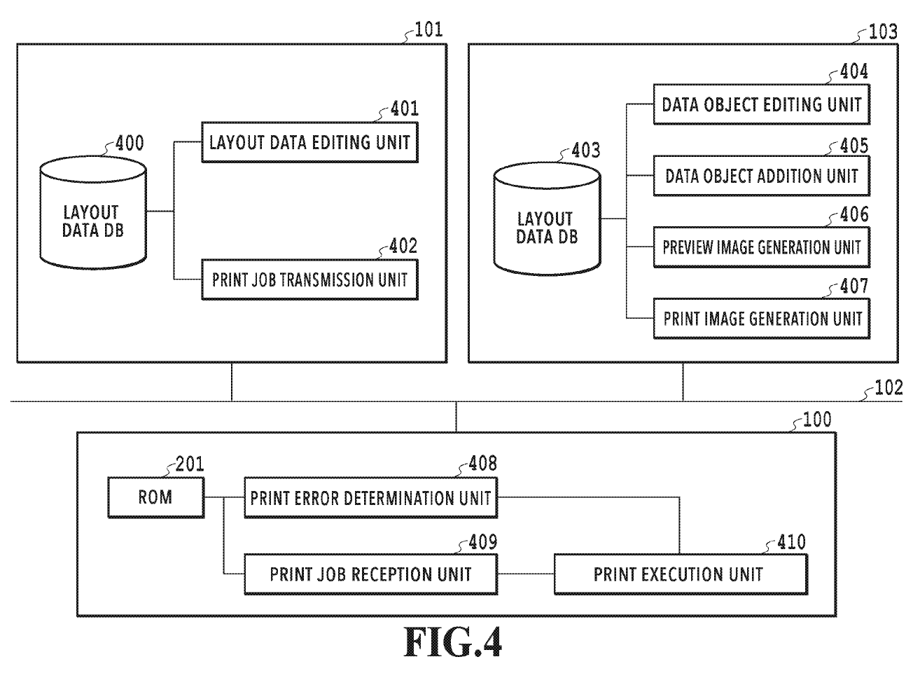

FIG. 4 is a block diagram illustrating functions of the print system. The information processing apparatus 101 includes a layout data DB 400, a layout data editing unit 401, and a print job transmission unit 402. The server PC 103 includes a layout data DB 403, a data object editing unit 404, a data object addition unit 405, a preview image generation unit 406, and a print image generation unit 407. The image output apparatus 100 includes the ROM 201, a print error determination unit 408, a print job reception unit 409, and a print execution unit 410.

### Information Processing Apparatus 101; Server PC 103

The layout data editing unit 401 performs internal processing corresponding to editing of an object by the user. The object is an editable element included in the layout data. The editable element has meaning that layout of the element is editable and meaning that the element itself is editable. The element corresponds to, for example, a text or an image to be put on a poster or a flyer. The text or the image serving as the element can be used as a minimum unit that is not deteriorated in image quality even when enlarged or reduced. In other words, the text or the image of the minimum unit that is not deteriorated in image quality even when enlarged or reduced may be used as the object. The text is represented by a character string. The character string used herein does not include a figure and an image, and includes only characters such as alphanumeric characters, kana characters, and various kinds of symbols. Further, characters constituting the character string may include outline characters and decorated characters. Furthermore, the character string may include characters of multiple languages.

The layout data is stored as a cache in the layout data DB 400 of the information processing apparatus 101. Alternatively, the layout data may be stored for each information processing apparatus 101 in the layout data DB 403 of the server PC 103. Further alternatively, in plate of storage for each information processing apparatus 101, the layout data may be stored for each account in the layout data DB 403 of the server PC 103. The account indicates a user account. In other words, in a case where the user account is present, the layout data may be stored for each user account in the layout data DB 403 of the server PC 103.

Editing of the object includes addition or deletion of the object. Alternatively, editing of the object includes change of the layout of the object, namely, editing processing for editing the layout of the element in response to operation by the user. In addition, editing of the object incudes editing of the object itself, namely, editing processing for editing the element itself in response to operation by the user. Examples of editing of the element itself include object processing operation. The object processing operation includes, for example, extraction or mark of the object. More specifically, in a case where the user performs the object processing operation, the layout data editing unit 401 requests the data object editing unit 404 of the server PC 103 to perform processing in order to perform processing corresponding to the object processing operation by the user.

The object included in the layout data can be set for each layer. Layers are used as a function of editing one drawing by dividing the drawing into hierarchies. For example, as a layer configuration, a plurality of layers including an upper layer and a lower layer arranged behind the upper layer.

Among the plurality of layers, a layer upper than, namely, on a front side of a specific layer is referred to as the upper layer. Among the plurality of layers, a layer at a top position, namely, at a forefront position may be referred to as a top layer. The upper layer may become the top layer. A layer lower than, namely, on a lower side of the upper layer is referred to as the lower layer.

The upper layer and the lower layer can include different objects. However, when the object included in the upper layer and the object included in the lower layer are printed to form printed matters, and tangible objects that are obtained by cutting out a cardboard by using the printed matters as paper patterns are arranged on a board, the following may occur depending on a thickness of the cardboard. A gap may be generated between the tangible objects. In this case, if a support filling the gap is absent, the tangible objects may not be arranged at intended positions. Therefore, the present embodiment enables the user to perform operation for adding supports of the objects. More specifically, in a case where the user performs the operation for adding the supports of the objects, the layout data editing unit 401 requests the data object addition unit 405 of the server PC 103 to perform processing in order to perform addition processing corresponding to the operation for adding the supports of the objects by the user. Details of the addition processing are described below. As described above, a cutout portion of paper medium having a certain thickness such as a cardboard by using a printed matter on which the object is printed, as a paper pattern is referred to as a tangible object.

The print job transmission unit 402 creates a print job, and transmits the created print job to the image output apparatus 100. To create the print job, the preview image generation unit 406 and the print image generation unit 407 of the server PC 103 are used. More specifically, the print job transmission unit 402 requests the preview image generation unit 406 of the server PC 103 to perform processing for generating a preview image of the layout data. Alternatively, the print job transmission unit 402 requests the print image generation unit 407 of the server PC 103 to perform processing for generating a print image of the layout data.

### Image Output Apparatus 100

The ROM 201 includes programs and various kinds of data for realizing functions of the print error determination unit 408, the print job reception unit 409, and the print execution unit 410. The print job reception unit 409 receives the print job transmitted from the information processing apparatus 101. In a case where the print job received by the print job reception unit 409 cannot be normally printed, the print error determination unit 408 detects a print error. For example, in a case where print setting included in the print job and the main body information are compared, and mismatch about a sheet occurs, the print error determination unit 408 determines that the print job received by the print job reception unit 409 cannot be normally printed. Alternatively, in a case where the print setting included in the print job and the main body information are compared, and a sheet size of the print job is too large, the print error determination unit 408 determines that the print job received by the print job reception unit 409 cannot be normally printed. In contrast, in a case where the print error determination unit 408 determines that the print job received by the print job reception unit 409 can be normally printed, the print execution unit 410 performs print processing based on the print job.

### Layout Data Editing Screen 500

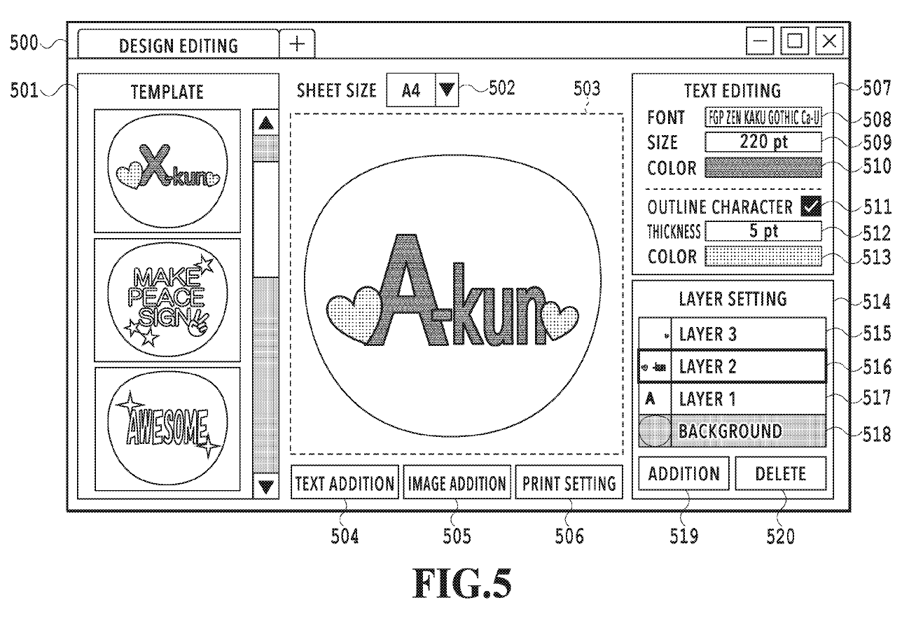

FIG. 5 is a diagram illustrating an example of a layout data editing screen 500 displayed on the display 309 of the information processing apparatus 101. The layout data editing screen 500 is displayed on the display 309 of the information processing apparatus 101. The layout data editing screen 500 in FIG. 5 is in a state where a "design editing" tab is selected. The layout data editing screen 500 includes a template list area 501, a layout editing area 503, a text editing area 507, and a layer setting area 514. In the following description, the user operates various kinds of buttons and the like displayed on the layout data editing screen 500, but it can be assumed that the operation depends on forms of the display 309 and the input device. For example, in a case where the display 309 is a liquid crystal display with a touch panel, the following can be assumed. Operation in which the user touches and presses a button of the layout data editing screen 500 displayed on the display 309 can be assumed. Alternatively, operation in which the user presses a button of the layout data editing screen 500 displayed on the display 309 by using an input device such as a touch pen can be assumed. Further, in a case where an input device such as a mouse is provided in addition to the display 309, operation in which the user clicks a button of the layout data editing screen 500 displayed on the display 309 by the mouse can be assumed.

### Template List Area 501

The template list area 501 is arranged on a left part of the layout data editing screen 500. In the template list area 501, various templates are displayed so as to be browsable, and an optional template is selectable from the displayed templates. For example, an optional temperate can be displayed and selected by operation of a scroll bar arranged at a right end of the template list area 501. The user can select a template closest to a desired completed form of layout data from these templates, and appropriately edit objects included in the template. The layout data that may become a template may be acquired from the layout data DBs 400 and 403 in FIG. 4. Alternatively, the layout data that may become a template may be taken in from an unillustrated external cloud service or SNS service. As the external cloud service, for example, a cloud storage is assumed. As a cloud storage, for example, Google Drive(R), Dropbox(R), OneDrive(R), and Box(R) are assumed. The layout data stored in such a cloud storage can be taken in as a template, and be edited. As the SNS service, for example, Microsoft Teams(R) is assumed. Alternatively, as the SNS service, Slack(R) may be assumed. The layout data stored in such a SNS service can be taken in as a template, and be edited. Further, a file stored in the external cloud service or the SNS service can be subjected to simultaneous collaborative editing, and accordingly, the layout data may be appropriately collaboratively edited. For example, in a case where a paper fan for cheering a "my fave" like an artist, layout data that is created for a special event corresponding to a birthday of the "my fave", namely, "birthday celebration", from existing layout data may be uploaded as a new template. When the new temperate is updated as described above, another user can download the uploaded template, and use the temperate for "supporting my fave" such as "birthday celebration". The template selected from the template list area 501 by the user is displayed in the layout editing area 503.

### Layout Editing Area 503

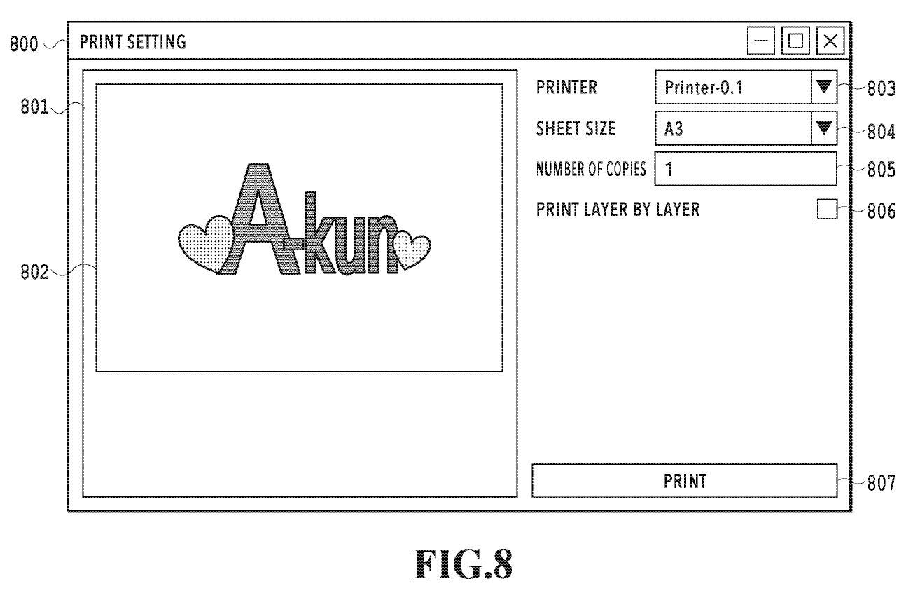

The layout editing area 503 is arranged at a center of the layout data editing screen 500. A sheet size setting area 502 is arranged above the layout editing area 503. A text addition button 504, an image addition button 505, and a print setting button 506 are arranged below the layout editing area 503. A pulldown button is arranged in the sheet size setting area 502. When the pulldown button is operated by the user, preset candidates for a sheet size are displayed as a list. This enables selection of a desired sheet size. Each of objects displayed in the layout editing area 503 is a target to be adjusted in position as editing of layout of an element, and is also a target to be extracted or marked as editing of the element itself. In a case where the user performs operation on each of the objects displayed in the layout editing area 503, the layout data editing unit 401 or the data object editing unit 404 performs corresponding processing. For example, in a case where the user operates the text addition button 504 or the image addition button 505, a file selection dialog may be called, a file path may be designated, and import processing may be performed. Alternatively, a button corresponding to a type of another object may be additionally arranged. Alternatively, the external cloud service or the SNS service may be designated as an import source of a new object. Alternatively, operation to add a new object by drag and drop of an object to the layout editing area 503 may be received. In a case where the user operates the print setting button 506, print setting is performed. Processing in the case where the print setting button 506 is operated is described below with reference to FIG. 8.

### Text Editing Area 507

The text editing area 507 is arranged on an upper right part of the layout data editing screen 500. The text editing area 507 is an area for receiving editing of a text in the layout data. Specifically, the text editing area 507 receives input of information on a font, a size, a color, and the like of the text in the layout data. More specifically, a font setting area 508, a text size setting area 509, and a text color setting area 510 are arranged on an upper part of the text editing area 507. On the other hand, an outline character setting checkbox 511, an outline character thickness setting area 512, and an outline character color setting area 513 are arranged on a lower part of the text editing area 507.

The font setting area 508 is an area for receiving setting of a font of the text. For example, the font setting area 508 may receive input of a font name from the user. Alternatively, the font setting area 508 may receive optional selection by the user from a preset font name list developed by operation of an unillustrated pulldown button. The text size setting area 509 is an area for receiving setting of a size of the text. For example, the text size setting area 509 may receive input of a numerical value indicating the size of the text from the user. Alternatively, the text size setting area 509 may receive optional selection by the user from a preset size list developed by operation of an unillustrated pulldown button. The text color setting area 510 is an area for receiving setting of a color of the text. For example, the text color setting area 510 may receive input of a color code from the user. Alternatively, the text color setting area 510 may receive selection of an optional color chip image by the user from preset color chip images developed by operation of an unillustrated pulldown button.

The outline character setting checkbox 511 is a checkbox for receiving setting of an outline character. The outline character is a character that is represented only by an outline and has a hollow center. In other words, the outline character is a character only having a contour. The outline character setting checkbox 511 can switch whether to display characters as outline characters by being operated by the user. The outline character thickness setting area 512 is an area for receiving setting of an outline character thickness. For example, the outline character thickness setting area 512 may receive input of a numerical value indicating the outline character thickness from the user. Alternatively, the outline character thickness setting area 512 may receive optional selection by the user from a preset thickness list developed by operation of an unillustrated pulldown button. The outline character color setting area 513 is an area for receiving setting of an outline character color. For example, the outline character color setting area 513 may receive input of a color code from the user. Alternatively, the outline character color setting area 513 may receive selection of an optional color chip image by the user from preset color chip images developed by operation of an unillustrated pulldown button. The layout data editing unit 401 or the data object editing unit 404 changes the text based on contents of the operation received by the user in the text editing area 507, and displays the changed text in the layout editing area 503.

The use example of the pulldown button is described as an interface for a detailed menu; however, the interface is not particularly limited thereto. For example, a dialog box may be displayed, and options as described above may be presented in the dialog box.

### Layer Setting Area 514

The layer setting area 514 is arranged on a lower right part of the layout data editing screen 500. The layer setting area 514 is an area for receiving setting about layers. Layer information display areas 515 to 518, a layer addition button 519, and a layer deletion button 520 are arranged in the layer setting area 514. Each of the layer information display areas 515 to 518 includes an outline display field for displaying outline of objects included in the own layer, and a name field for displaying a name of the own layer. The outline display field displays reduced objects. Further, when the objects are reduced and displayed in the outline display field, the objects are displayed at arrangement positions in the corresponding layer. In the name field, a name is set based on a stacking order of the layers. For example, a "layer 1" in the name field in FIG. 5 indicates a lowest layer. A "layer 2" in the name field in FIG. 5 indicates an upper layer of the "layer 1". A "layer 3" in the name field in FIG. 5 indicates an upper layer of the "layer 2". A "background" in the name field in FIG. 5 indicates a background layer of the lowest layer. Further, out of two layers adjacent along hierarchies of the layers, objects included in the upper layer are appropriately referred to as upper objects, and objects included in the lower layer behind the upper layer are appropriately referred to as lower objects. Next, setting of the layers using the layer setting area 514 is described.

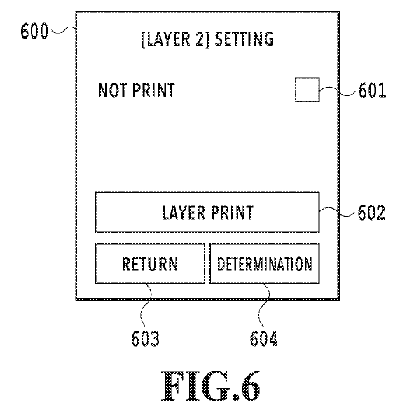

For example, in a case where the user operates the text addition button 504 or the image addition button 505 in a state where the user selects one of the layer information display areas 515 to 517, the following processing is performable. Specifically, processing for adding an object such as a text and an image to the layer selected by the user is performable. On the other hand, in a case where the user operates the text addition button 504 or the image addition button 505 in a state where the user does not select one of the layer information display areas 515 to 517, the following processing is performable. Specifically, processing for creating a new layer as a forefront layer, and adding a text and an image to the created layer is performable. The forefront layer is the top layer, and is a layer arranged on an upper side of the "layer 3" in the example in FIG. 5. The anteroposterior-relationship of the objects can be changed by editing the stacking order of the layers. The anteroposterior-relationship of the objects is upper/lower relationship of the upper objects that are the objects included in the upper layer and the lower objects that are the objects included in the lower layer. In the example in FIG. 5, the objects included in the layers are displayed in the layout editing area 503 so as to be partially overlapped in order of the layers based on the setting of the layer setting area 514. At this time, for example, when the layer addition button 519 is operated by the user, processing for adding a top layer to the layer setting area 514 is performed. When the layer deletion button 520 is operated by the user, processing for deleting a layer from the layer setting area 514 is performed. Next, specific processing when the layer setting area 514 is operated is described with reference to FIG. 6.

### Layer Setting Screen 600

FIG. 6 is a diagram illustrating an example of a layer setting screen 600 displayed on the display 309 of the information processing apparatus 101. When an optional layer is selected by the user in the layer setting area 514 in FIG. 5, and predetermined operation is performed by the user, the layer setting screen 600 in FIG. 6 is displayed. The predetermined operation is, for example, input of a specific key performed through an unillustrated pointing device. The predetermined operation is not limited to operation through the unillustrated pointing device. For example, when the optional layer is selected by the user in the layer setting area 514 in FIG. 5, the layer setting screen 600 may be displayed in response to double click of a mouse. Alternatively, after the optional layer is selected by the user in the layer setting area 514 in FIG. 5, the layer setting screen 600 may be displayed in response to operation of a function key of a keyboard. A layer print setting checkbox 601, a layer print button 602, a return button 603, and a determination button 604 are arranged in the layer setting screen 600. When the user operates the layer print setting checkbox 601, it is possible to switch whether to print a target layer that is selected in the layer setting area 514 in FIG. 5. For example, in a case where operation for checking the layer print setting checkbox 601 is performed, the target layer is set not to be printed. Alternatively, in a case where the operation for checking the layer print setting checkbox 601 is not performed, the target layer is set to be printed. It is assumed that the background layer displayed in the layer information display area 518 in FIG. 5 is set not to be printed because the layer print setting checkbox 601 is checked by the user through the layer setting screen 600 in FIG. 6. Therefore, to clarify that the background layer is set not to be printed, the layer information display area 518 in FIG. 5 is displayed with hatching. Further, when the layer print button 602 is operated by the user, the layout data editing unit 401 in FIG. 4 requests the print job transmission unit 402 in FIG. 4 to create a print job of the target layer and to transmit the created print job to the image output apparatus 100. When the return button 603 is operated by the user, the CPU 300 in FIG. 3 performs processing for returning the screen to the layout data editing screen 500 in FIG. 5 without reflecting various kinds of setting contents through the layer setting screen 600 in FIG. 6. When the determination button 604 is operated by the user, the CPU 300 in FIG. 3 performs processing for returning the screen to the layout data editing screen 500 in FIG. 5 after reflecting various kinds of setting contents through the layer setting screen 600 in FIG. 6. The layer setting screen 600 may be displayed on an entire display screen of the display 309, or may be displayed as a pop-up window. Next, layout data is described.

### Layout Data 700: Layer Configurations 701 to 703

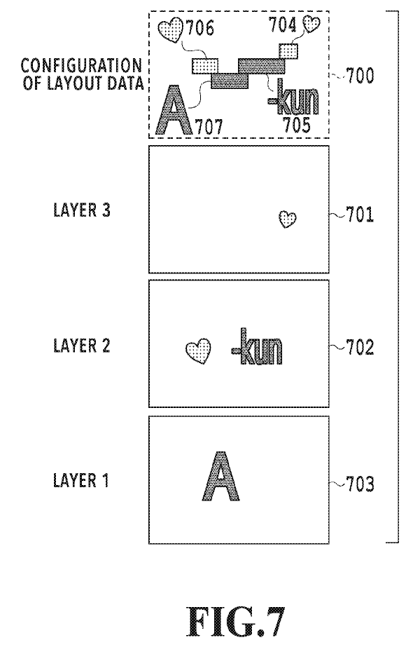

FIG. 7 is a diagram illustrating examples of layout data 700 and layer configurations 701 to 703. The layout data 700 in FIG. 7 is data indicating arrangement positions for each layer, of objects displayed in the layout editing area 503 in FIG. 5, and hierarchical configurations of the layers. The layer configurations 701 to 703 in FIG. 7 respectively correspond to the layers 3 to 1 illustrated in the layer information display areas 515 to 517 in FIG. 5. In other words, the layer configuration 701 corresponds to the layer 3 including an image 704, the layer configuration 702 corresponds to the layer 2 including a text 705 and an image 706, and the layer configuration 703 corresponds to a layer 1 including a text 707. Note that, since the background layer illustrated in the layer information display area 518 in FIG. 5 is set not to be printed, the background layer is omitted in FIG. 7. Next, processing in a case where the print setting button 506 in FIG. 5 is operated is described with reference to FIG. 8.

### Print Setting Screen 800

FIG. 8 is a diagram illustrating an example of a print setting screen 800 displayed on the display 309 of the information processing apparatus 101. When the print setting button 506 in FIG. 5 is operated, the print setting screen 800 in FIG. 8 is displayed. A print preview area 801, a printer setting area 803, a sheet size setting area 804, a number-of-copies setting area 805, a layer-by-layer print setting checkbox 806, and a print execution button 807 are arranged in the print setting screen 800. The print preview area 801 is arranged on a left part of the print setting screen 800. A preview image 802 is displayed in the print preview area 801. The preview image 802 is generated by the preview image generation unit 406 in FIG. 4 based on the setting contents set in the layout data editing screen 500 in FIG. 5, the layer setting screen 600 in FIG. 6, and the print setting screen 800 in FIG. 8. The preview image 802 in FIG. 8 is displayed based on the layout data 700 in FIG. 7. As described above, the layout data 700 in FIG. 7 is data edited in the layout data editing screen 500 in FIG. 5. Note that, since the background layer illustrated in the layer information display area 518 in FIG. 5 is set not to be printed, the background layer is not displayed in the preview image 802 in FIG. 8.

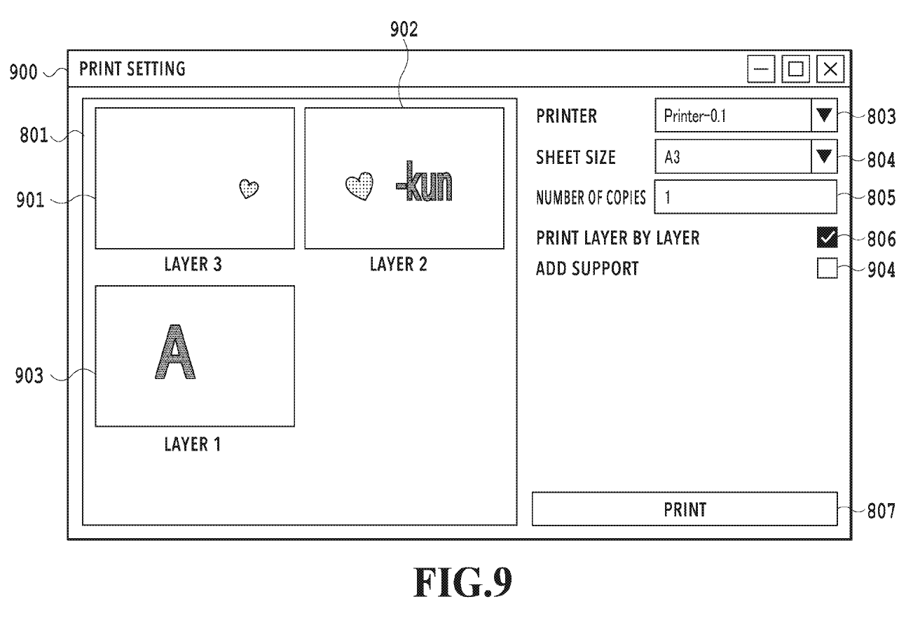

The printer setting area 803 is arranged on an upper side of a right part of the print setting screen 800. The printer setting area 803 is an area for receiving selection of a printer performing printing. In the example in FIG. 8, a pulldown button is arranged at a right end of the printer setting area 803. When the user operates the pulldown button, a preset printer list is displayed, and a desired printer is selectable. The sheet size setting area 804 is arranged below the printer setting area 803. The sheet size setting area 804 is an area for receiving setting of a sheet size. In the example in FIG. 8, a pulldown button is arranged at a right end of the sheet size setting area 804. When the user operates the pulldown button, a preset sheet size list is displayed, and a desired sheet size is selectable. The number-of-copies setting area 805 is arranged below the sheet size setting area 804. The number-of-copies setting area 805 is an area for receiving setting of the number of copies. In the example in FIG. 8, a state where the number-of-copies setting area 805 has received input of "1" as the number of copies is illustrated. The print execution button 807 is arranged on a lower side of the right part of the print setting screen 800. The print execution button 807 is a button for receiving a print execution instruction. When the print execution button 807 is operated by the user, the layout data editing unit 401 in FIG. 4 requests the print job transmission unit 402 in FIG. 4 to create a print job based on the layout data and to transmit the created print job to the image output apparatus 100. The layout data used to create the print job is the layout data 700 in FIG. 7 used to display the preview image 802 in FIG. 8. The layer-by-layer print setting checkbox 806 is arranged at a right end below the number-of-copies setting area 805. The layer-by-layer print setting checkbox 806 is a checkbox for receiving whether to print layer by layer. In other words, the layer-by-layer print setting checkbox 806 is an interface for switching processing to any of processing for printing all layers in combination and processing for printing layer by layer. In a case where only one layer is provided, the layer-by-layer print setting checkbox 806 is not displayed. The print setting screen 800 may be displayed on the entire display screen of the display 309, or may be displayed as a pop-up window. Next, processing in a case where the processing is switched to the processing for printing layer by layer through the layer-by-layer print setting checkbox 806 is described with reference to FIG. 9.

FIG. 9 is a diagram illustrating an example of a print setting screen 900 in a case where an instruction to print layer by layer is received on the print setting screen 800 in FIG. 8. Differences from the print setting screen 800 in FIG. 8 are mainly described. In place of the preview image 802 in FIG. 8, preview images 901 to 903 are displayed in the print preview area 801. The preview images 901 to 903 respectively correspond to the layer configurations 701 to 703. In a case where the layer-by-layer print setting checkbox 806 is operated, and the processing is switched to the processing for printing layer by layer, a support addition setting checkbox 904 is arranged below the layer-by-layer print setting checkbox 806. The support addition setting checkbox 904 is a checkbox for receiving whether to switch processing to processing for adding supports. Every time the support addition setting checkbox 904 is operated by the user, the processing can be switched to any of the processing for adding supports and processing for adding no support. Next, a use case where the support addition setting checkbox 904 is operated and the processing is switched to the processing for adding supports is described.

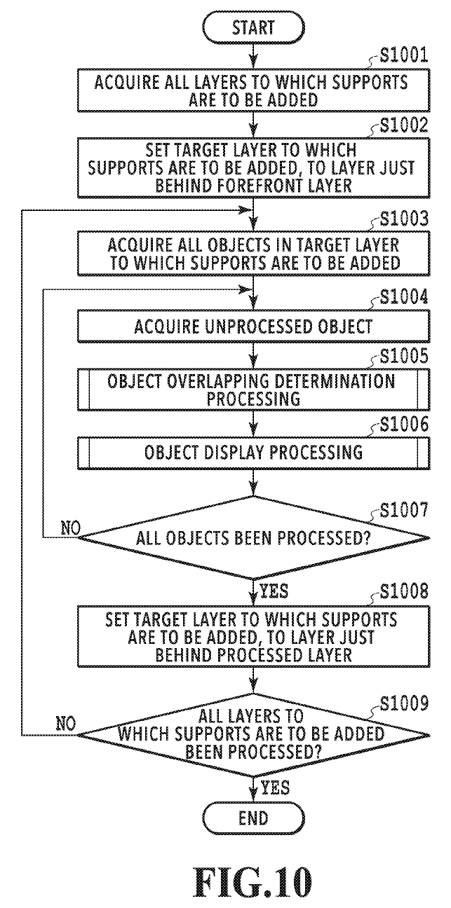

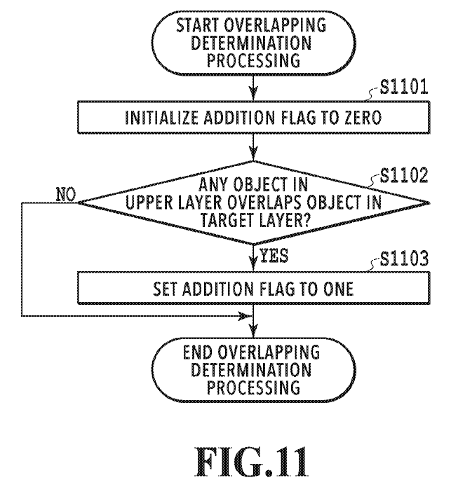

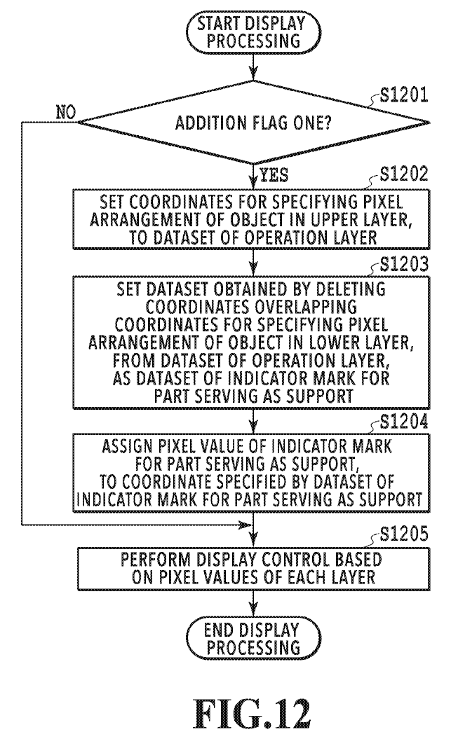

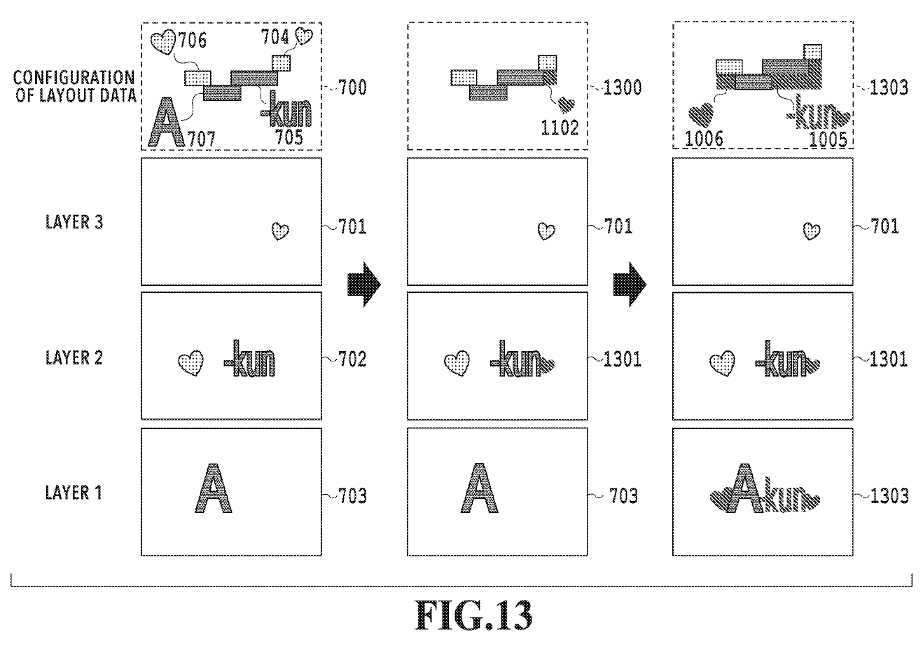

FIG. 10 is a flowchart illustrating additional object addition processing. FIG. 11 is a flowchart illustrating object overlapping determination processing in S1005 in FIG. 10. FIG. 12 is a flowchart illustrating object display processing in S1006 in FIG. 10. FIG. 13 is a transition diagram of layout data by the additional object addition processing. The additional object addition processing in FIG. 10 is performed by the data object addition unit 405 in FIG. 4. The data object addition unit 405 in FIG. 4 receives request of the additional object addition processing from the layout data editing unit 401 in FIG. 4 at a timing when the support addition setting checkbox 904 in FIG. 9 is operated. When the additional object addition processing is requested, the CPU of the server PC 103 reads out various kinds of programs stored in the ROM of the server PC 103 to the RAM of the server PC 103 and executes the various kinds of programs, thereby realizing the additional object addition processing. A part or all of functions of steps in FIGS. 10 to 12 may be realized by hardware such as an ASIC and an electronic circuit. A symbol "S" in description of each processing means step in the flowcharts. The additional object addition processing in FIG. 10 can also be realized as a configuration of cloud computing in which one function is shared by a plurality of resources and is processed in cooperation through the Internet. For example, the processing may be shared in such a manner that a part of the processing is performed by the server PC 103 and remaining processing is performed by an unillustrated server different from the server PC 103. More specifically, S1001 to S1004, and S1007 to S1009 may be performed by the server PC 103, and S1005 and S1006 may be performed by the unillustrated server different from the server PC 103. Alternatively, in a case where a load to the server 103 is increased by the other processing while the server PC 103 performs the additional object addition processing in FIG. 10, a part of the processing may be performed by the information processing apparatus 101. The server PC 103 may function as the information processing apparatus 101 to perform the processing illustrated in the flowcharts in FIGS. 10 to 12.

In S1001, the data object addition unit 405 acquires all layers to which supports are to be added. For example, the layer configurations 701 to 703 in FIG. 7 are acquired. All layers to which supports are to be added means all layers to which supports may be added. In S1002, the data object addition unit 405 sets a target layer to which supports are to be added, to a layer just behind the forefront layer. For example, when the forefront layer is the layer 3, the layer just behind the forefront layer is the layer 2. In this case, the target layer to which supports are to be added is set to the layer 2. In S1003, the data object addition unit 405 acquires all objects in the target layer to which supports are to be added. For example, the text 705 and the image 706 included in the layer 2 are acquired. In S1004, the data object addition unit 405 acquires an unprocessed object. For example, the text 705 acquired by the processing in S1003 is acquired. In S1005, the data object addition unit 405 performs object overlapping determination processing. The object overlapping determination processing is described with reference to FIG. 11.

### Object Overlapping Determination Processing

FIG. 11 is a flowchart illustrating the object overlapping determination processing in S1005 in FIG. 10. In S1101, the data object addition unit 405 initializes an addition flag to zero. In S1102, the data object addition unit 405 determines whether there is an upper object in an upper layer overlapping a lower object in a lower layer that is the target layer. In a case where it is determined that there is an upper object overlapping the lower object, the data object addition unit 405 causes the processing in S1102 to proceed to processing in S1103. In S1103, the data object addition unit 405 sets the addition flag to one, ends the processing in S1103, and causes the processing to proceed to processing in S1006 in FIG. 10. In contrast, in a case where it is determined that there is no upper object overlapping the lower object, the data object addition unit 405 ends the processing in S1102, and causes the processing to proceed to the processing in S1006 in FIG. 10. In other words, it is determined whether the upper object included in the upper layer has a portion overlapping the lower object included in the lower layer that is the target layer. For example, a part of the image 704 included in the layer 3 overlaps a part of the text 705 included in the layer 2. In other words, the image 704 that is the upper object has a portion overlapping the text 705 that is the lower object. In this case, the processing in S1101, the processing in S1102, and the processing in S1103 are successively performed. The overlapping arrangement relationship of the upper object and the lower object can be determined by referring to the layout data 700 in FIG. 7. Next, the object display processing in S1006 in FIG. 10 is described with reference to FIG. 12.

### Object Display Processing

FIG. 12 is a flowchart illustrating the object display processing in S1006 in FIG. 10. In S1201, the data object addition unit 405 determines whether the addition flag is one. In a case where the data object addition unit 405 determines that the addition flag is one, the data object addition unit 405 causes the processing in S1201 to proceed to processing in S1202.

In S1202, the data object addition unit 405 sets coordinates for specifying pixel arrangement of the object in the upper layer, to dataset of an operation layer. The object includes an aggregate of pixels. Therefore, the pixel arrangement of the object in the upper layer indicates a position where the aggregate of a plurality of pixels constituting the object in the upper layer is arranged. Arrangement of each of the pixels can be specified by a coordinate. Therefore, the arrangement of the aggregate of the plurality of pixels constituting the object can be specified as an aggregate of coordinates of the plurality of pixels constituting the object. In the following, the aggregate of coordinates of the plurality of pixels constituting the object is referred to as a coordinate set.

More specifically, a dataset of the image 704 included in the layer 3 is set to A(Layer3, coordinate set ((a1, b1), ..., (an, bn))). A dataset of the image 706 and the text 705 included in the layer 2 is set to B(Layer2, coordinate set ((c1, d1), ..., (cm, dm))). A dataset of the operation layer is set to C(-, coordinate set ((-, -), ..., (-, -))). Coordinates for specifying the pixel arrangement of the image 704 included in the layer 3 that is the upper layer are set to the dataset of the operation layer. As a result, C(Layer3, coordinate set ((a1, b1), ..., (an, bn))) is set.

In S1203, the data object addition unit 405 sets a dataset that is obtained by deleting coordinates overlapping coordinates for specifying pixel arrangement of the object in the lower layer, from the dataset of the operation layer, as a dataset of an indicator mark for a part serving as a support. More specifically, coordinates overlapping the B coordinate set ((c1, d1), ..., (cm, dm)) are deleted from the C coordinate set ((a1, b1), ..., (an, bn)). The coordinate set obtained by deleting the overlapping coordinates is set as a coordinate set ((a'1, b'1), ..., (a'n, b'n)). By the processing, the dataset of the indicator mark for the part serving as the support is set to S(Layer2, coordinate set ((a'1, b'1), ..., (a'n, b'n))).

In S1204, the data object addition unit 405 assigns a pixel value of the indicator mark for the part serving as the support, to a coordinate specified by the dataset of the indicator mark for the part serving as the support. More specifically, the data object addition unit 405 assigns a pixel value for the support to each of coordinates specified by the coordinate set ((a'1, b'1), ..., (a'n, b'n)).

In S1205, the data object addition unit 405 performs display control based on pixel values of each layer, and causes the processing to proceed to processing in S1007 in FIG. 10. In contrast, in a case where the data object addition unit 405 determines that the addition flag is not one, the data object addition unit 405 causes the processing in S1201 to proceed to the processing in S1205, performs the processing in S1205, and then causes the processing to proceed to the processing in S1007 in FIG. 10.

In other words, in a pixel arrangement area in the layer 2 corresponding to a pixel arrangement area of a "right-inclined heart" of the image 704 in the layer 3, except for a pixel arrangement region overlapping the text 705 in the layer 2, pixels corresponding to the "right-inclined heart" are assigned. More specifically, the layer configuration 702 in FIG. 13 is transited to a layer configuration 1301. As a result, an additional object 1120 in FIG. 13 is added. The additional object 1102 in FIG. 13 serves as an indicator mark for a part serving as the support of the image 704. For example, when the additional object 1102 is printed, a tangible object that corresponds to the additional object 1102 and has a thickness can be produced by cutting out a cardboard or the like by using a printed matter as a paper pattern. In short, the coordinates overlapping the coordinates for specifying the arrangement position of the lower object are deleted from the coordinates for specifying the arrangement position of the upper object. The coordinates obtained by deleting the coordinates overlapping the coordinates for specifying the arrangement position of the lower object are set as coordinates for specifying an arrangement position of the additional object. Further, the tangible object that is produced by cutting out a cardboard or the like by using the printed matter of the additional object as a paper pattern is also referred to as a tangible additional object. The pixel arrangement area is an area occupied by a plurality of arranged pixels constituting an object included in a layer, on a two-dimensional plane specified by a layer.

In S1007, the data object addition unit 405 determines whether all objects have been processed. In a case where the data object addition unit 405 determines that all object have not been processed, the data object addition unit 405 returns the processing in S1007 to the processing in S1004. In other words, until all objects are processed, the processing in S1004 to S1006 is repeated. For example, among the objects in the layer 2 that is the target layer, the text 705 has been processed, but the image 706 has not been processed. Therefore, as with the text 705, the data object addition unit 405 determines whether the image 704 in the layer 3 overlaps the image 706 in the layer 2. The image 704 in the layer 3 does not overlap the image 706 in the layer 2. Therefore, the additional object addition processing is not performed.

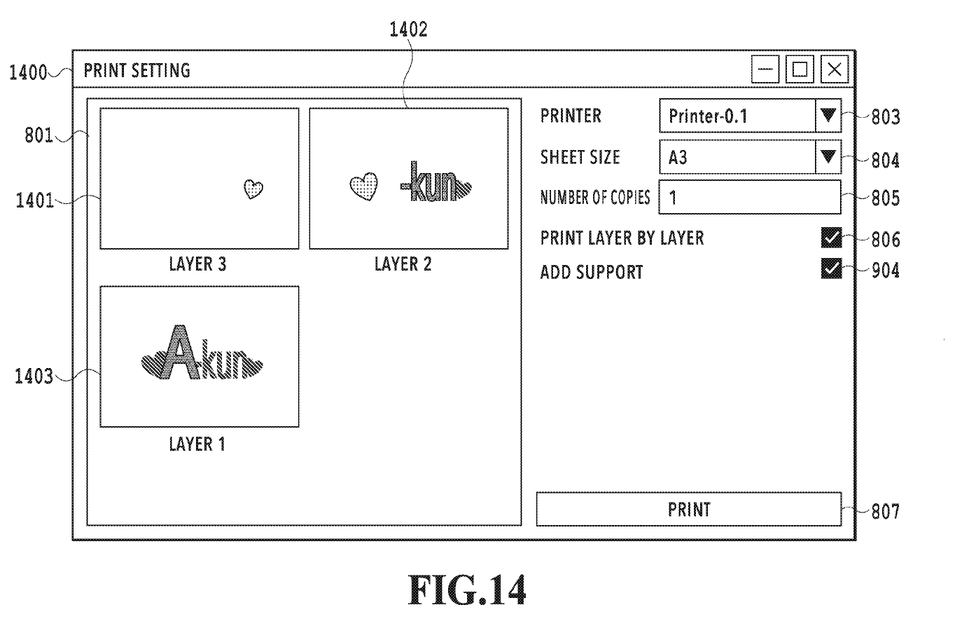

In contrast, in a case where the data object addition unit 405 determines that all objects have been processed, the data object addition unit 405 causes the processing in S1007 to proceed to processing in S1008. In S1008, the data object addition unit 405 sets the target layer that is a layer to which supports are to be added, to a layer just behind the processed layer. In other words, the layer 1 becomes the target layer. In S1009, the data object addition unit 405 determines whether all layers to which supports are to be added have been processed. In a case where the data object addition unit 405 determines that all layers to which supports are to be added have been processed, the data object addition unit 405 ends the processing. In contrast, in a case where the data object addition unit 405 determines that all layers to which supports are to be added have not been processed, the data object addition unit 405 returns the processing in S1009 to the processing in S1003, and repeats the processing in S1003 to S1008. A part of the image 706 and a part of the text 705 in the layer 2 overlap the text 707 in the layer 1. Further, the additional object 1102 has been added to the layer 2, and the additional object 1102 and the text 705 are arranged adjacently to each other in the same layer. Thus, in a case where the additional object 1102 and the text 705 are used as paper patterns, it is assumed that the additional object 1102 and the text 705 are integrated as a tangible object. Therefore, it is assumed that a gap corresponding to a thickness of the tangible object of the text 707 is formed between a board and the tangible object in which the additional object 1102 and the text 705 are integrated. Therefore, it is considered that the text 705 and the additional object adjacent thereto overlap a part of the text 707. Therefore, it is considered that a part of the image 706 in the layer 2 and a part of an object in which the text 705 and the additional object 1102 are integrated overlap the text 707 in the layer 1. As a result, as illustrated in FIG. 13, new additional objects 1005 and 1006 are added, and the layer configuration 703 is transited to a layer configuration 1303. When the processing of the layer 1 is completed as described above, the processing of all layers to which supports are to be added is completed, and the processing in FIGS. 10 to 12 ends. Next, a processing result of the additional object addition processing is described with reference to FIG. 14.

FIG. 14 is a diagram illustrating an example of the processing result of the additional object addition processing. Differences between a print setting screen 1400 in FIG. 14 and the print setting screen 900 in FIG. 9 are mainly described. In place of the preview images 901 to 903 in FIG. 9, preview images 1401 to 1403 are displayed in the print preview area 801. The preview images 1401 to 1403 respectively correspond to the layer configurations 701, 1301, and 1303. The user can obtain printed matters based on the layout data added with supports by operating the print execution button 807.

In the present embodiment, the processing collectively adds the additional objects that are the indicator marks for the parts serving as the supports of the upper objects, to the plurality of target layers; however, the processing is not particularly limited thereto. For example, an additional object that is an indicator mark for a part serving as a support of an upper object may be added to an optional layer. For example, in the layer setting screen 600 in FIG. 6, a checkbox for adding an additional object that is an indicator mark for a part serving as a support of an upper object to an optional layer may be arranged. In a case where an additional object that is an indicator mark for a part serving as a support of an upper object is added to an optional layer, the data object addition unit 405 performs the processing in S1003 to S1006. As a result, the data object addition unit 405 adds an additional object. Alternatively, the additional object may be added to be grouped by being added to a target object that is an object included in the target layer. For example, the text 705 and the additional object 1102 are in the same layer and are adjacent to each other. Therefore, the processing may be executed based on a premise of grouping. Alternatively, the additional object may be added as a target object in the target layer. In other words, an appearance of the target object may be extended so as to become an object including a part overlapping the upper object. In a case where the additional object is added as the target object in the target layer, the same additional object is added to all layers behind the target layer. In other words, in place of processing for adding an additional object for each layer, processing for adding an additional object to all levels of the layers may be performed from the outset. Alternatively, in a case where a user interface (UI) like the support addition setting checkbox 904 is not arranged, processing for adding an additional object may be automatically performed irrespective of user operation.

As described above, in the present embodiment, the processing for displaying and controlling objects is performed based on overlapping of the plurality of objects. The tangible objects that are produced from the additional objects by cutting out a cardboard or a color board by using the printed matters based on the layout data as paper patterns can fill the gaps among the objects. Therefore, in a case where the tangible objects produced from the upper objects are stacked on the tangible additional objects produced from the additional objects, the tangible objects produced from the objects can be easily stacked at intended positions.

### SECOND EMBODIMENT

In the first embodiment, the example in which the additional objects each having a preset shape are added as the supports is described. In a second embodiment, an example in which a support shape is changed by receiving change of the support shape from the user, to facilitate stacking is described. Differences from the print setting screen 900 according to the first embodiment are mainly described.

### Shape Change Outline

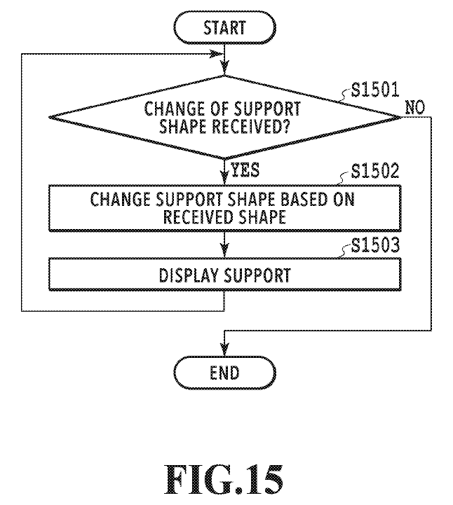

FIG. 15 is a flowchart illustrating support shape change processing according to the second embodiment. The support shape change processing illustrated in FIG. 15 is realized when the CPU of the server PC 103 reads out programs stored in the ROM of the server PC 103 to the RAM 302 of the server PC 103, and executes the programs. At a timing when the object addition processing described in the first embodiment ends and the supports are added, the layout data editing unit 401 requests the data object addition unit 405 to perform processing, and the support shape change processing in FIG. 15 is started.

In S1501, the data object addition unit 405 determines whether change of a support shape has been received. The support shape means attributes relating to the additional object, for example, a color, presence or absence of a boundary line, presence or absence of display of a glue margin, a display magnification, and whether to display the additional object similarly to the forefront object. Therefore, change of the support shape means change of the attributes relating to the additional object. In a case where change of the support shape has not been received, the data object addition unit 405 ends the processing in S1501. In a case where change of the support shape has been received, the data object addition unit 405 causes the processing in S1501 to proceed to processing in S1502. In S1502, the data object addition unit 405 changes the support shape based on a received shape. In S1503, the data object addition unit 405 displays the changed support, and ends the processing. For example, the support is displayed as a preview image in the print preview area 801. Next, specific examples of change of the support shape are described below.

### Change of Support Shape; Color

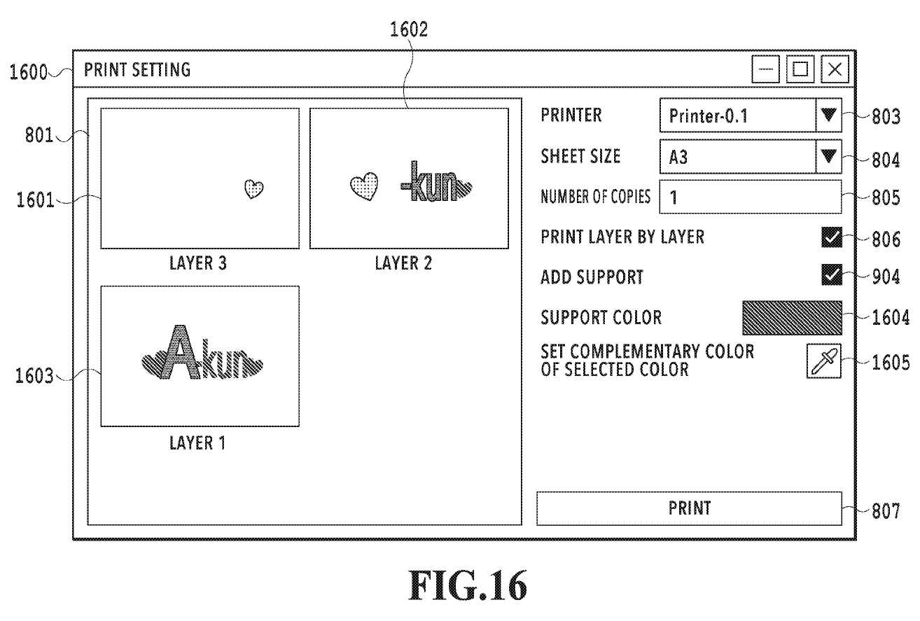

FIG. 16 is a diagram illustrating an example of a print setting screen 1600 in a case where a support color is set according to the second embodiment. As compared with the first embodiment, a support color setting area 1604 and an automatic support color setting button 1605 are arranged in the print setting screen 1600 according to the present embodiment. The support color setting area 1604 is an area for receiving setting of the support color. For example, the support color setting area 1604 may receive input of a color code as the support color from the user. Alternatively, the support color setting area 1604 may receive, as the support color, selection of an optional color chip image by the user from preset color chip images developed by operation of an unillustrated pulldown button. The automatic support color setting button 1605 is a button for receiving setting of the support color by preset reference. In the preset reference, for example, a complementary color of a selected color is set as the support color. When the automatic support color setting button 1605 is operated by the user, a cursor is changed to a dropper tool, and a complementary color of a color of a clicked object is set to the support color setting area 1604. The data object addition unit 405 adds an additional object serving as a support based on the setting of the support color setting area 1604. The preview image generation unit 406 generates preview images based on the settings of the layer setting screen 600 and the print setting screen 1600, and displays preview images 1601 to 1603 in the print preview area 801. In the above-described manner, for example, by changing the support color to the complementary color of the color of the adjacent object, the position of the support is often easily understood, which makes it possible to facilitate stacking of the tangible object on the support.

### Change of Support Shape; Presence or Absence of Boundary Line

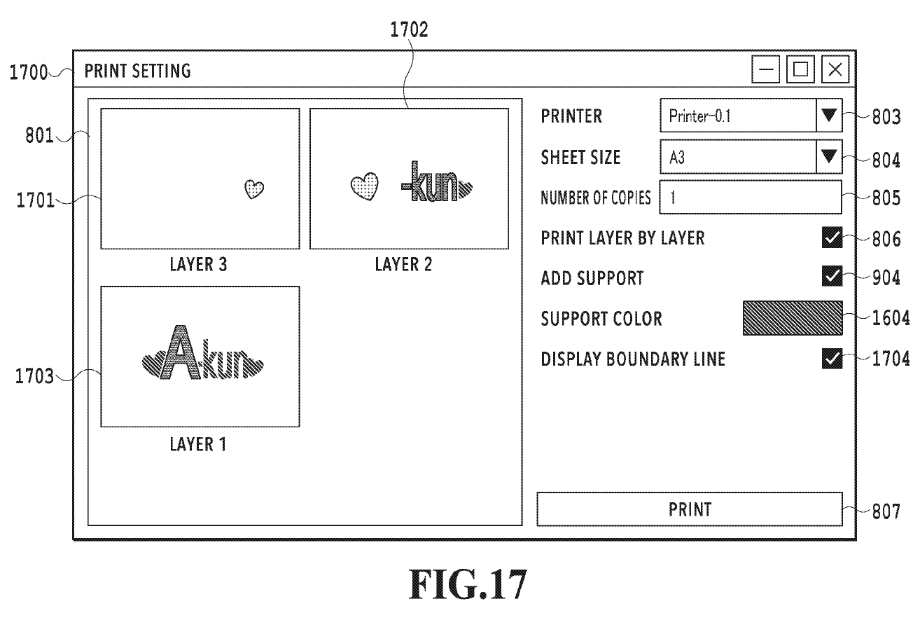

FIG. 17 is a diagram illustrating an example of a print setting screen in a case where a boundary line between a support and an object is displayed according to the second embodiment. As compared with the first embodiment, the support color setting area 1604 and a boundary line display checkbox 1704 are arranged in a print setting screen 1700 according to the present embodiment. The boundary line display checkbox 1704 is a checkbox for receiving setting whether to display a boundary line between a support and an object. In other words, the boundary line display checkbox 1704 is a checkbox for receiving setting whether to display a boundary line between an additional object and an object. The data object addition unit 405 adds a support, namely, an additional object based on setting contents of the support color setting area 1604 and the boundary line display checkbox 1704. The preview image generation unit 406 generates preview images 1701 to 1703 based on the setting contents of the layer setting screen 600 and the print setting screen 1700, and displays the preview images 1701 to 1703 in the print preview area 801. When the boundary line between the support and the object is displayed, a position of the support is easily understood, which makes it possible to facilitate stacking of the tangible object on the support.

### Change of Support Shape; Presence or Absence of Display of Glue Margin

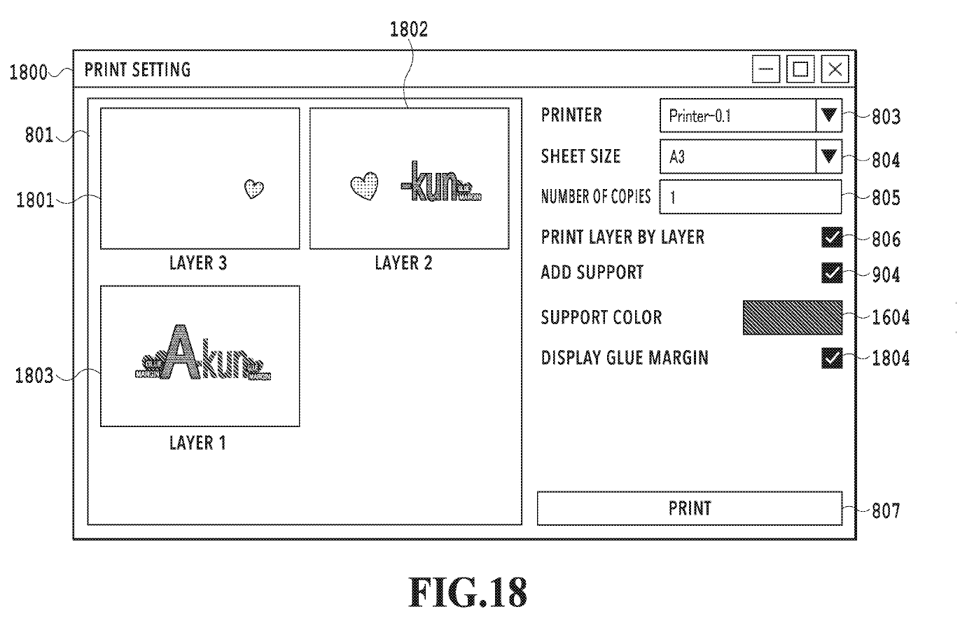

FIG. 18 is a diagram illustrating an example of a print setting screen in a case where a glue margin is displayed according to the second embodiment. As compared with the first embodiment, the support color setting area 1604 and a glue margin display checkbox 1804 are arranged in a print setting screen 1800 according to the present embodiment. The glue margin display checkbox 1804 is a checkbox for receiving setting whether to display a character string indicating that an object serves as a support, for example, a character string represented by a text of "glue margin". The data object addition unit 405 adds a support, namely, an additional object based on setting contents of the support color setting area 1604 and the glue margin display checkbox 1804. The preview image generation unit 406 generates preview images 1801 to 1803 based on the setting contents of the layer setting screen 600 and the print setting screen 1800, and displays the preview images 1801 to 1803 in the print preview area 801. When the character string indicating the support is displayed, a position of the support is easily understood, which makes it possible to facilitate stacking of the tangible object on the support.

### Change of Support Shape; Display Magnification

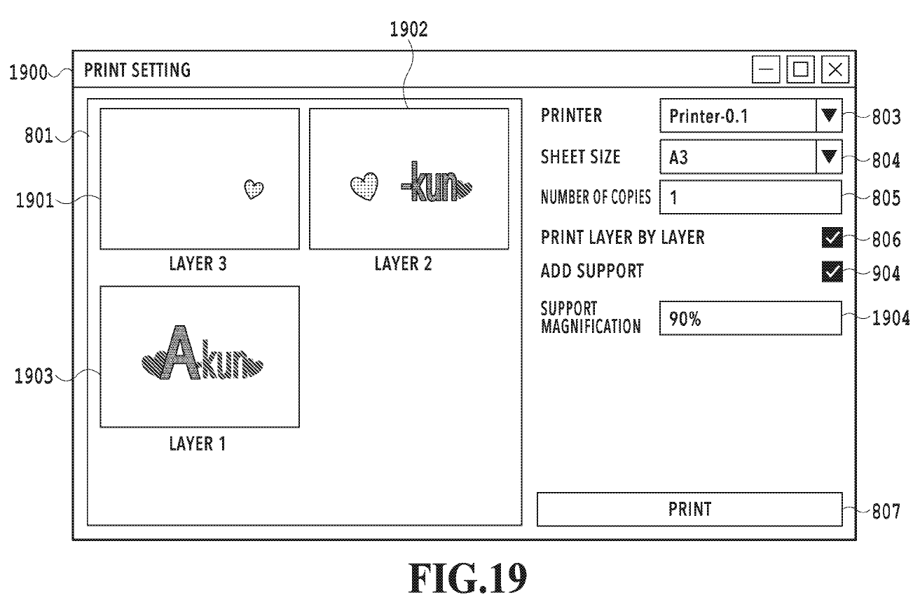

FIG. 19 is a diagram illustrating an example of a print setting screen in a case where a support magnification is displayed according to the second embodiment. As compared with the first embodiment, a support magnification setting area 1904 is arranged in a print setting screen 1900 according to the present embodiment. The support magnification setting area 1904 is an area for receiving setting of a display size of a support. For example, a numerical value indicating a support magnification may be input to the support magnification setting area 1904. Alternatively, preset magnifications may be displayed as a selectable list, by an unillustrated pulldown menu in the support magnification setting area 1904. In a case where an additional object serving as a support is an image, a size of the additional object is changed to realize the magnification received in the support magnification setting area 1904. In a case where the additional object serving as the support is a text, a font is set from a font family so as to realize display close to the magnification received in the support magnification setting area 1904. The data object addition unit 405 adds an additional object serving as a support based on the setting contents of the support magnification setting area 1904. The preview image generation unit 406 generates preview images 1901 to 1903 based on the setting contents of the layer setting screen 600 and the print setting screen 1900, and displays the preview images 1901 to 1903 in the print preview area 801. In a case where the support magnification is set and the support is reduced more than the object stacked on the support, the support is hardly viewed when the object is stacked as the tangible object, which makes it possible to facilitate stacking of the tangible object on the support.

### Change of Support Shape; Whether to Display Additional Object Similarly to Forefront Object

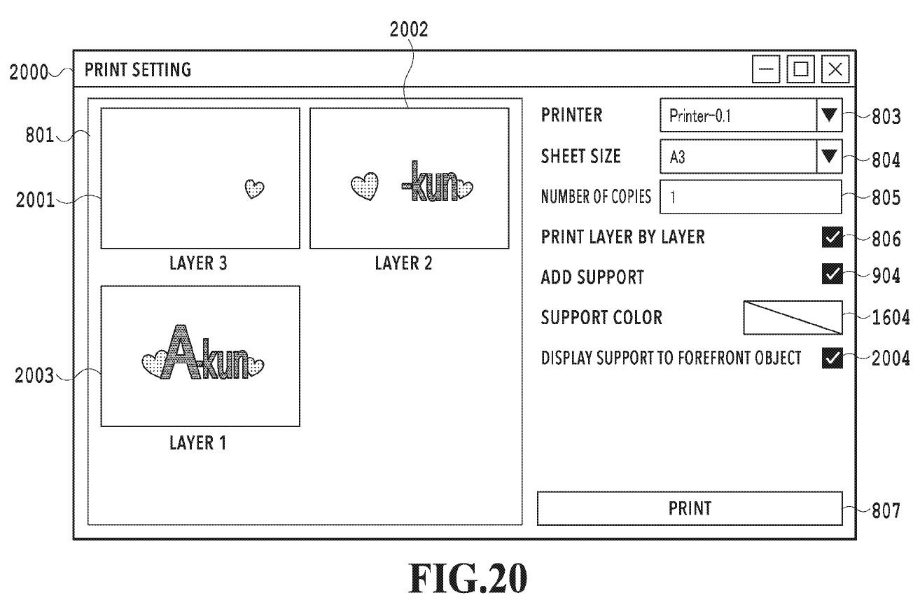

FIG. 20 is a diagram illustrating an example of a print setting screen in a case where a support color is set to a color of a forefront object according to the second embodiment. As compared with the first embodiment, the support color setting area 1604 and a support forefront objectification checkbox 2004 are arranged in a print setting screen 2000 according to the present embodiment. The support forefront objectification checkbox 2004 is a checkbox for receiving setting whether to display a support similarly to a forefront object. In a case where an additional object serving as a support is display similarly to a forefront object, the support color setting area 1604 is displayed with, for example, an inclined line, and is not selectable. The data object addition unit 405 adds an additional object serving as a support based on the setting contents of the support color setting area 1604 and the support forefront objectification checkbox 2004. The preview image generation unit 406 generates preview images 2001 to 2003 based on the setting contents of the layer setting screen 600 and the print setting screen 2000, and displays the preview images 2001 to 2003 in the print preview area 801. When the support is displayed similarly to the forefront object, in a case where the object is stacked as a tangible object, even if a position of the support is not completely coincident with a position of the tangible object, the color of the forefront object is viewed, which prevents an appearance from being deteriorated. This makes it possible to facilitate stacking of the tangible object on the support with a good appearance.

### THIRD EMBODIMENT

In the second embodiment, the example in which change of the attributes of the support is received as change of the support shape from the user, to facilitate stacking of the tangible object on the support is described. In a third embodiment, an example in which, as change of attributes of a support, an ink saving instruction in printing is received from the user is described. In particular, in the present embodiment, processing in a case where printing is performed layer by layer is described.

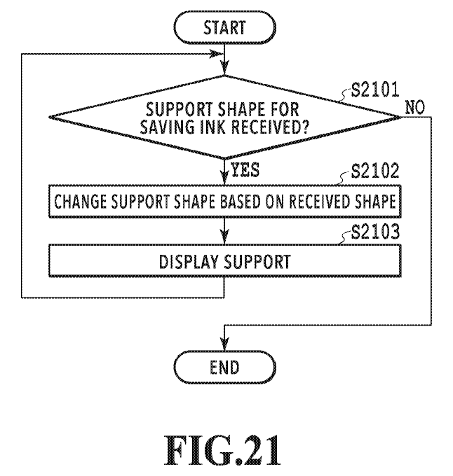

FIG. 21 is a flowchart illustrating additional object ink saving processing according to the third embodiment. The additional object ink saving processing illustrated in FIG. 21 is realized when the CPU of the server PC 103 reads out programs stored in the ROM of the server PC 103 to the RAM 302 of the server PC 103, and executes the programs. At a timing when the object addition processing described in the first embodiment ends and the supports are added, the layout data editing unit 401 requests the data object addition unit 405 to perform processing, and the additional object ink saving processing in FIG. 21 is started.

In S2101, the data object addition unit 405 determines whether a support shape for saving ink has been received. The support shape means attributes relating to the support, namely, the attributes relating the additional object as described in the second embodiment. In a case where the support shape for saving ink has not been received, the data object addition unit 405 ends the processing in S2101. In a case where the support shape for saving ink has been received, the data object addition unit 405 causes the processing to proceed to processing in S2102. In S2102, the data object addition unit 405 changes the support shape based on the received shape. In S2103, the data object addition unit 405 displays the changed support, and ends the processing. For example, the support is displayed as a preview image in the print preview area 801.

### Ink Saving; Only Contour

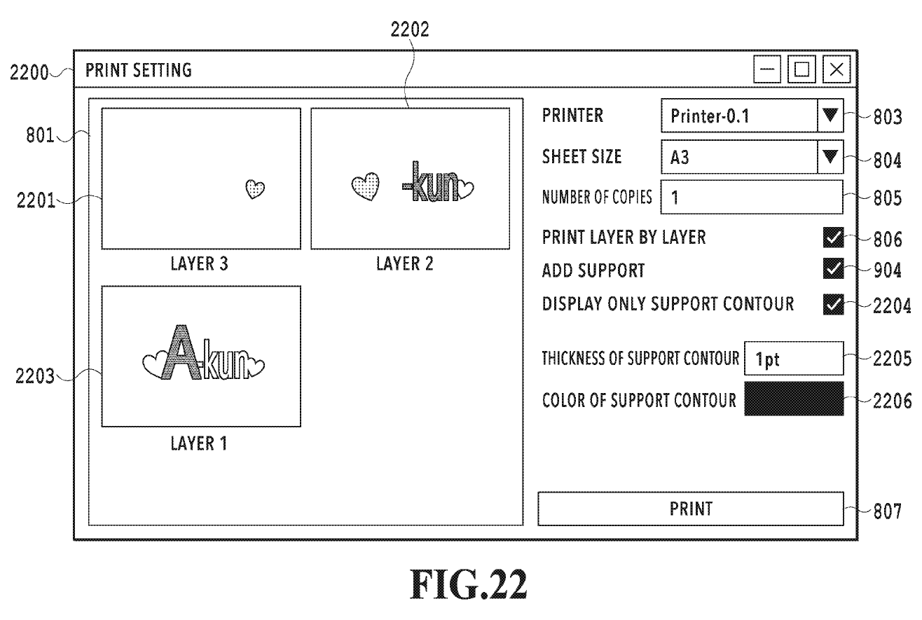

FIG. 22 is a diagram illustrating an example of a print setting screen 2200 in a case where only a contour of a support is displayed according to the third embodiment. A support contour display checkbox 2204, a support contour thickness setting area 2205, and a support contour color setting area 2206 are arranged in the print setting screen 2200. The support contour display checkbox 2204 is a checkbox for receiving a switching instruction whether to display only a contour of a support. The support contour thickness setting area 2205 is an area for receiving setting of a contour thickness of a support. The support contour thickness setting area 2205 may receive input of a numerical value indicating the contour thickness of the support. Alternatively, the support contour thickness setting area 2205 may display preset thicknesses as a selectable list, by an unillustrated pulldown menu. The support contour color setting area 2206 is an area for receiving setting of a contour color of a support. The support contour color setting area 2206 may receive, as the contour color of the support, input of a color code from the user. Alternatively, the support contour color setting area 2206 may receive, as the contour color of the support, selection of an optional color chip image by the user from preset color chip images developed by operation of an unillustrated pulldown button. The data object addition unit 405 adds an additional object serving as a support based on the setting contents of the support contour display checkbox 2204, the support contour thickness setting area 2205, and the support contour color setting area 2206. The preview image generation unit 406 generates preview images based on the settings of the layer setting screen 600 and the print setting screen 2200, and displays preview images 2201 to 2203 in the print preview area 801. As a result, only the counter is printed as the support, which makes it possible to reduce a consumed amount of ink.

### Ink Saving; Gray

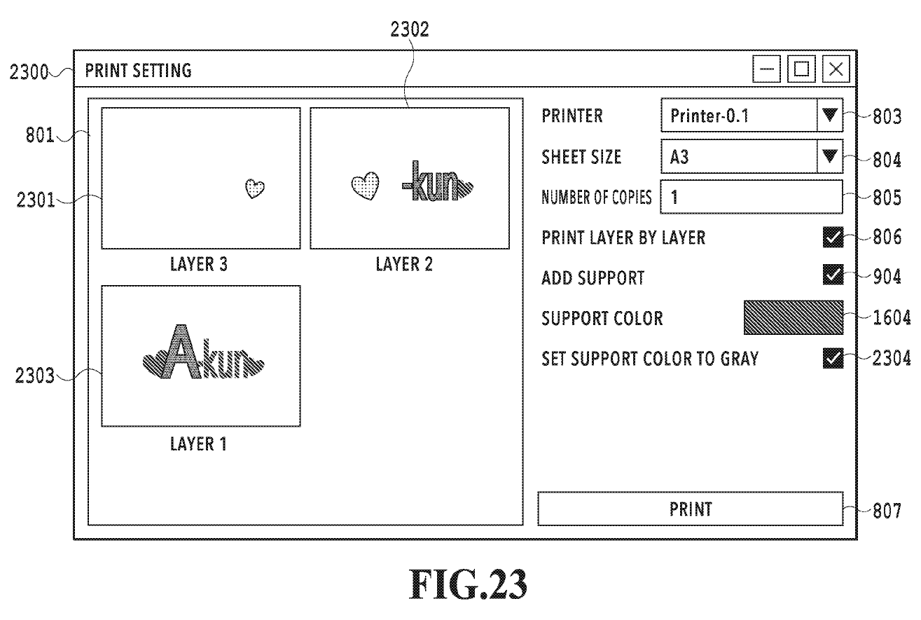

FIG. 23 is a diagram illustrating an example of a print setting screen 2300 in a case where a support color is set to gray according to the third embodiment. The support color setting area 1604 and an ink saving checkbox 2304 are arranged in the print setting screen 2300. The support ink saving checkbox 2304 is a checkbox for receiving setting whether to set a support color to a color small in consumed amount of ink in printing. For example, gray is set as the support color. The data object addition unit 405 adds an additional object serving as a support based on the setting contents of the support color setting area 1604 and the support ink saving checkbox 2304. The preview image generation unit 406 generates preview images based on the settings of the layer setting screen 600 and the print setting screen 2300, and displays preview images 2301 to 2303 in the print preview area 801. As a result, the support is printed in gray and the consumed amount of ink can be reduced. In place of gray, the support may be printed in grayscale. Even in a case of grayscale, the consumed amount of ink can be reduced.

### FOURTH EMBODIMENT

In the third embodiment, the example in which ink in printing is saved by receiving change of the attributes relating to the support as change of the support shape from the user is described. In a fourth embodiment, an example of receiving whether to automatically arrange objects from the user is described. In particular, in the present embodiment, as an example of saving sheets in printing, processing in a case where printing is performed layer by layer is described.

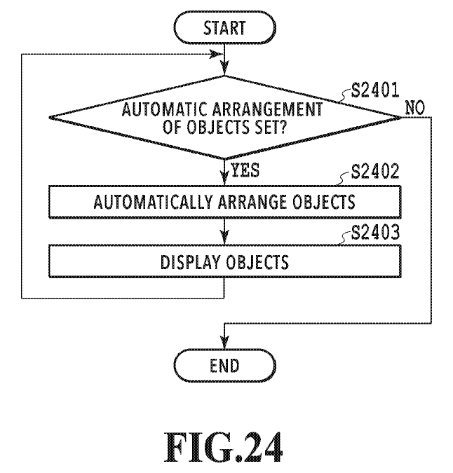

FIG. 24 is a flowchart illustrating automatic object arrangement processing according to the fourth embodiment. The automatic object arrangement processing illustrated in FIG. 24 is realized when the CPU of the server PC 103 reads out programs stored in the ROM of the server PC 103 to the RAM 302 of the server PC 103, and executes the programs. At a timing when the object addition processing described in the first embodiment ends and the supports are added, the layout data editing unit 401 requests the data object editing unit 404 to perform processing, and the automatic object arrangement processing in FIG. 24 is started.

In S2401, the data object editing unit 404 receives whether to automatically arrange objects. In a case where inexecution of automatic object arrangement is received, the processing in S2401 ends. In a case where execution of automatic object arrangement is received, the processing in S2401 proceeds to processing in S2402. In S2402, the data object editing unit 404 automatically arranges objects based on preset reference. In S2403, the data object editing unit 404 generates preview images in which arrangement of the objects is updated, and displays the preview images in the print preview area 801.

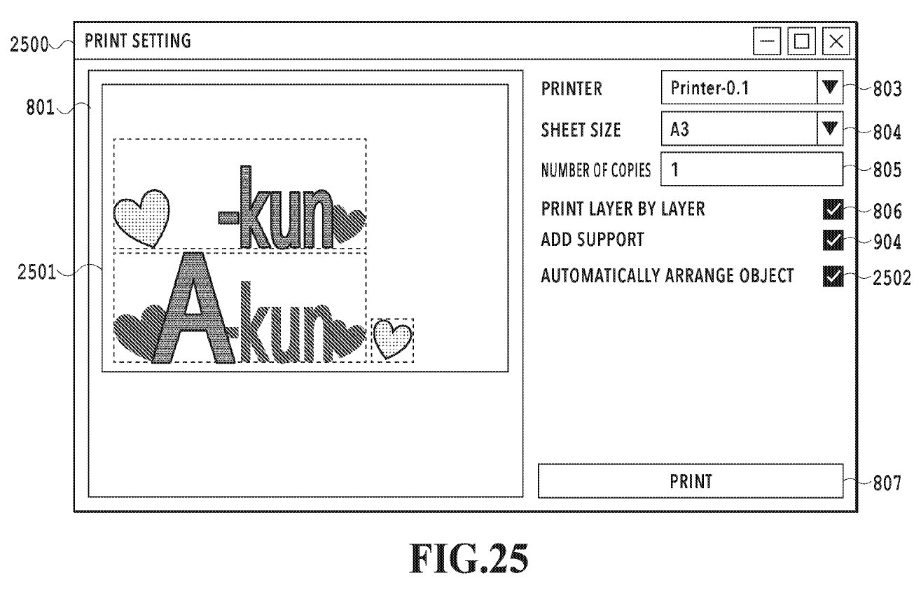

FIG. 25 is a diagram illustrating an example of a print setting screen 2500 in a case where objects are automatically arranged according to the fourth embodiment. An automatic object arrangement checkbox 2502 is arranged in the print setting screen 2500. The automatic object arrangement checkbox 2502 is a checkbox for receiving setting whether to automatically arrange objects in layers in order to print the objects on a small number of sheets. As an arrangement method, for example, a bottom-left algorithm (https://www.msi.co.jp/solution/nuopt/docs/glossary/articles/Bottom-LeftAlgorithm.html) is used. The data object editing unit 404 automatically arranges objects based on the setting contents of the automatic object arrangement checkbox 2502. The preview image generation unit 406 generates a preview image based on the setting contents of the layer setting screen 600 and the print setting screen 2500, and displays a preview image 2501 in the print preview area 801. This makes it possible to change arrangement of the objects, and to print the objects on a smaller number of sheets. Therefore, automatic object arrangement makes it possible to save sheets used in printing.

### OTHER EMBODIMENTS

Although various examples and embodiments of the present disclosure are described above, the spirit and the scope of the present disclosure are not limited to specific description in the present specification. The present disclosure is not limited to the above-described embodiments, and may be variously modified. In addition, parts of the above-described embodiments of the present disclosure may be appropriately combined.

### FIRST MODIFICATION

For example, the present disclosure can be realized by performing the following processing. Software (programs) realizing functions of the above-described embodiments may be supplied to a system or an apparatus through a network or various kinds of storage media. In this case, a computer (or CPU, MPU, etc.) of the system or the apparatus reads out the programs and executes the processing. As a result, the present disclosure can be realized.

### SECOND MODIFICATION

In the above-described embodiments, the layout data creation application is described as the example of the application; however, the application is not limited to the example. The above-described embodiments can be realized by an optional application including a similar image layout function, and effects similar to the effects by the embodiments can be achieved.

### THIRD MODIFICATION

In the above-described embodiments, a personal computer is assumed as the information processing apparatus. However, the information processing apparatus is not limited to the example. For example, the above-described embodiments can be realized by an optional information processing apparatus (terminal) that can be similarly used, for example, a mobile phone, a mobile information terminal, a digital still camera, a digital video camera, a portable music player, a game, a set-top box, and an Internet appliance. Further, effects similar to the effects by the embodiments can be achieved.

### FOURTH MODIFICATION

In the above-described embodiments, as the configuration example of the network, Ethernet is used; however, the network configuration is not limited thereto, and an optional network configuration, for example, a wireless LAN, IEEE1394, or Bluetooth may be used.

### FIFTH MODIFICATION

The function of adding additional objects serving as supports described above may be realized, for example, as a plugin function to be incorporated in an existing image editing application.

### SIXTH MODIFICATION

Various kinds of input contents described above may be received through a screen keyboard.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the present disclosure, it is possible to improve usability relating to the processing based on the produced matters.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-018550, filed Feb. 6, 2025 which is hereby incorporated by reference herein in its entirety.

What is claimed is:

1. A non-transitory computer-readable storage medium storing instructions that, when executed by a processor, cause the processor to perform a method comprising:
a position setting step of setting an arrangement position of an additional object indicating a part serving as a support of an upper object, in a lower layer behind an upper layer including the upper object; and
a display control step of displaying and controlling the additional object set in arrangement position in the position setting step.

2. The computer-readable storage medium according to claim 1, wherein the position setting step includes processing for setting coordinates that are obtained by deleting coordinates overlapping coordinates for specifying an arrangement position of a lower object included in the lower layer, from coordinates for specifying an arrangement position of the upper object, as coordinates for specifying the arrangement position of the additional object.

3. The computer-readable storage medium according to claim 2, wherein the display control step includes processing for controlling display of the additional object based on the coordinates for specifying the arrangement position of the additional object.

4. The computer-readable storage medium according to claim 3, further comprising an editing step of receiving editing for setting a plurality of layers at least including the upper layer and the lower layer.

5. The computer-readable storage medium according to claim 4, wherein the editing step includes processing for receiving editing of contents including the upper object and the lower object.

6. The computer-readable storage medium according to claim 3, further comprising:
a reception step of receiving change of attributes relating to the additional object; and
a change step of changing the attributes relating to the additional object based on the change of the attributes relating to the additional object.

7. The computer-readable storage medium according to claim 6, wherein the change step includes processing for changing a color of the additional object as the change of the attributes relating to the additional object.

8. The computer-readable storage medium according to claim 7, wherein the change step includes processing for setting a color of the additional object to be printed in gray or grayscale as the change of the attributes relating to the additional object.

9. The computer-readable storage medium according to claim 6, wherein the change step includes processing for displaying a boundary line between the additional object and the lower object as the change of the attributes relating to the additional object.

10. The computer-readable storage medium according to claim 6, wherein the change step includes processing for adding a predetermined character string to a surface of the additional object as the change of the attributes relating to the additional object.

11. The computer-readable storage medium according to claim 6, wherein the change step includes processing for reducing a size of the additional object more than a size of the upper object as the change of the attributes relating to the additional object.

12. The computer-readable storage medium according to claim 6, wherein the change step includes processing for setting a color of the additional object to a color same as a color of the upper object as the change of the attributes relating to the additional object.

13. The computer-readable storage medium according to claim 6, wherein the change step includes processing for setting a contour of the additional object to be printed and an inside of the contour of the additional object not to be printed as the change of the attributes relating to the additional object.

14. The computer-readable storage medium according to claim 3, further comprising an arrangement determination step of determining an arrangement in a case where the upper object, the lower object, and the additional object are printed on one sheet in a manner of a bottom-left algorism.

15. An information processing method, comprising:
a position setting step of setting an arrangement position of an additional object indicating a part serving as a support of an upper object, in a lower layer behind an upper layer including the upper object; and
a display control step of displaying and controlling the additional object set in arrangement position in the position setting step.

16. An information processing apparatus, comprising:
a position setting unit configured to set an arrangement position of an additional object indicating a part serving as a support of an upper object, in a lower layer behind an upper layer including the upper object; and
a display control unit configured to display and control the additional object set in arrangement position by the position setting unit.
